(19) United States
(12) Patent Application Publication
(10) Pub. No.: US 2015/0242766 A1
(43) Pub. Date: Aug. 27, 2015

(54) SYSTEMS AND METHODS FOR PROVIDING PRICE PROTECTION FOR PRODUCTS

(71) Applicant: FLYR, INC., San Francisco, CA (US)

(72) Inventor: Alexander W.T.J. Mans, San Francisco, CA (US)

(73) Assignee: FLYR, INC., San Francisco, CA (US)

(21) Appl. No.: 14/629,286

(22) Filed: Feb. 23, 2015

Related U.S. Application Data
(60) Provisional application No. 61/943,293, filed on Feb. 21, 2014.

(51) Int. Cl. G06Q 10/02; G06Q 30/06

(52) U.S. Cl. CPC G06Q 10/02; G06Q 30/06

(57) ABSTRACT

A method comprises identifying specifications of an offer for a flight ticket on a flight available at a specific price to a user; offering price protection for a specific time period; if purchased, then during the specified time period: monitoring alternative flight tickets for a different deal to offer, and if the user purchases the different deal, then terminating the price protection; if a current price for the flight ticket with the specifications on the specific flight increases above the specific price, then determining whether to offer the flight ticket or an alternative at a discounted price below its current asking price, and if the user purchases the flight ticket or alternative at the discounted price, then terminating the price protection; and if the current price increases to a higher price and the user purchases the ticket at the higher price, then paying the difference and terminating the price protection.

### CROSS-REFERENCE TO RELATED APPLICATIONS

This application claims the benefit of and hereby incorporates by reference U.S. Provisional Patent Application Ser. No. 61/943,293, filed Feb. 21, 2014, and entitled “Method Enabling Volatility and Fulfillment Risk Protection for Perishable, Yield Managed Products And Services Across Suppliers and Distributors Without Market Signaling.” In addition, this application hereby incorporates by reference U.S. Nonprovisional patent application Ser. No. 14/629,200, filed Feb. 23, 2015, and entitled “Systems and Methods of Product Conversion Verification for Price Protection Claim Settlement.”

### BACKGROUND

Individuals often use third party intermediated marketplace systems to locate products (goods and/or services) of interest, to monitor prices and to make purchases. For many perishable, yield managed products, such as airlines tickets and hotel rooms, there is significant price volatility. Prices increase and decrease without warning. A consumer is often unaware whether a price for a product is fair or exorbitant. This volatility and lack of clarity frustrates consumers, who are left making decisions in the dark. It would be helpful to have systems and methods capable of supporting a consumer.

### SUMMARY

The following implementations and aspects thereof are described and illustrated in conjunction with systems, tools, and methods that are meant to be exemplary and illustrative, not necessarily limiting in scope. In various implementations one or more of the above-described problems have been addressed, while other implementations are directed to other improvements.

Systems and methods of the present invention for providing price protection of price volatile, yield managed, and perishable products at a specific product price.

In some embodiments, the present invention provides a method comprising identifying one or more airline flight specifications of an airline flight ticket offer for an airline flight ticket on a specific flight available at a specific price to a user; offering price protection at a price protection price for the airline flight ticket with the one or more airline flight specifications on the specific flight, the price protection being a promise that the airline flight ticket with the one or more airline flight specifications on the specific flight can be purchased at or below the specific price during a specified time period, unless no airline flight ticket with the one or more airline flight specifications on the specific flight remains available; if the user purchases the price protection, then during the specified time period: if the user has not purchased the airline flight ticket with the one or more airline flight specifications on the specific flight, monitoring alternative airline flight tickets for a different deal to offer to the user, and if the user purchases the different deal, then terminating the price protection; if the user has not purchased the airline flight ticket with the one or more airline flight specifications on the specific flight or the different deal, and if a current price for the airline flight ticket with the one or more airline flight specifications on the specific flight increases above the specific price, then determining whether to offer the airline flight ticket or an alternative airline flight ticket at a discounted price below its current asking price, and if the user purchases the airline flight ticket or the alternative airline flight ticket at the discounted price, then terminating the price protection; and if the current price for the airline flight ticket with the one or more airline flight specifications on the specific flight increases above the specific price to a higher price, and if the user purchases the airline flight ticket at the higher price, then paying the difference between the higher price and the specific price and terminating the price protection.

The one or more airline flight specifications may include dates of travel and seat class. The different deal may include a price lower than the specific price. The different deal may include a purchase incentive. The step of paying the difference may include paying the difference to the user. The step of paying the difference may include paying the difference to the provider of the airline flight. The step of paying the difference may include paying the difference to a third party marketplace.

The method may further comprise the step of, if during the specified time period no airline flight ticket with the one or more airline flight specifications on the specific flight remains available, and if the user has not purchased the airline flight ticket with the one or more airline flight specifications on the specific flight remains available, the different deal or the alternative airline flight ticket at the discounted price, paying a penalty to the user. The method may further comprise sending a product alert to inform the user of the different deal. The method may further comprise sending a product alert to inform the user of the availability of airline flight tickets with the one or more airline flight specifications on the specific flight. The method may further comprise sending a product alert to inform the user of the airline flight ticket or the alternative airline flight ticket at the discounted price.

In some embodiments, the present invention provides a system comprising: a communications engine configured to identify one or more airline flight specifications of an airline flight ticket offer for an airline flight ticket on a specific flight available at a specific price to a user; a price protection conversion settlement engine configured to offer price protection at a price protection price for the airline flight ticket with the one or more airline flight specifications on the specific flight, the price protection being a promise that the airline flight ticket with the one or more airline flight specifications on the specific flight can be purchased at or below the specific price during a specified time period, unless no airline flight ticket with the one or more airline flight specifications on the specific flight remains available; a current product alert management engine configured to, if the user has not purchased the airline flight ticket with the one or more airline flight specifications on the specific flight, monitor alternative airline flight tickets for a different deal to offer to the user during the specified time period; a damage mitigation engine configured to, if the user has not purchased the airline flight ticket with the one or more airline flight specifications on the specific flight or the different deal, and if a current price for the airline flight ticket with the one or more airline flight specifications on the specific flight increases above the specific price, determine whether to offer the airline flight ticket or an alternative airline flight ticket at a discounted price below its current asking price; and a product conversion settlement engine configured to, if the current price for the airline flight ticket with the one or more airline flight specifications on the specific flight increases above the specific price to a higher price, and if the user purchases the airline flight ticket at the higher price, pay the difference between the higher price and the specific price and terminating the price protection.

The one or more airline flight specifications may include dates of travel and seat class. The different deal may include a price lower than the specific price. The different deal may include a purchase incentive. The product conversion settlement engine may be configured to pay the difference to the user. The product conversion settlement engine may be configured to pay the difference includes paying the difference to the provider of the airline flight. The product conversion settlement engine may be configured to pay the difference includes paying the difference to a third party marketplace. The damage mitigation engine may be further configured to, if during the specified time period no airline flight ticket with the one or more airline flight specifications on the specific flight remains available, and if the user has not purchased the airline flight ticket with the one or more airline flight specifications on the specific flight remains available, the different deal or the alternative airline flight ticket at the discounted price, determine to pay a penalty to the user. The current product alert management engine may be further configured to send a product alert to inform the user of the availability of airline flight tickets with the one or more airline flight specifications on the specific flight. The current product alert management engine may be further configured to send a product alert to inform the user of the airline flight ticket or the alternative airline flight ticket at the discounted price.

In some embodiments, the present invention provides a system comprising: means for identifying one or more airline flight specifications of an airline flight ticket offer for an airline flight ticket on a specific flight available at a specific price to a user; means for offering price protection at a price protection price for the airline flight ticket with the one or more airline flight specifications on the specific flight, the price protection being a promise that the airline flight ticket with the one or more airline flight specifications on the specific flight can be purchased at or below the specific price during a specified time period, unless no airline flight ticket with the one or more airline flight specifications on the specific flight remains available; means for, during the specified time period, if the user has not purchased the airline flight ticket with the one or more airline flight specifications on the specific flight, monitoring alternative airline flight tickets for a different deal to offer to the user, and if the user purchases the different deal, then terminating the price protection; means for, during the specified time period, if the user has not purchased the airline flight ticket with the one or more airline flight specifications on the specific flight or the different deal, and if a current price for the airline flight ticket with the one or more airline flight specifications on the specific flight increases above the specific price, then determining whether to offer the airline flight ticket or an alternative airline flight ticket at a discounted price below its current asking price, and if the user purchases the airline flight ticket or the alternative airline flight ticket at the discounted price, then terminating the price protection; and means for, during the specified time period, if the current price for the airline flight ticket with the one or more airline flight specifications on the specific flight increases above the specific price to a higher price, and if the user purchases the airline flight ticket at the higher price, then paying the difference between the higher price and the specific price and terminating the price protection.

### BRIEF DESCRIPTION OF THE DRAWINGS

FIG. 1 is a block diagram of a price protection network system, according to some embodiments.

FIG. 2 depicts an example price protection system, according to some embodiments.

FIG. 3 depicts an example current and historical product data store, according to some embodiments.

FIG. 4 depicts an example third party intermediated marketplace system, according to some embodiments.

FIG. 5 depicts an example user system, according to some embodiments.

FIG. 6 depicts an example computer system, according to some embodiments.

FIG. 7 depicts an example product data management system, according to some embodiments.

FIG. 8 is a flowchart of an example of a method for providing price protection for a price volatile, yield managed, and perishable product.

FIG. 9 is a flowchart of an example of a method for sending product alerts to a user as part of providing price protection.

FIG. 10 is a flowchart of an example of a method for performing damage mitigation in providing price protection.

FIG. 11 is a flowchart of an example of a method for settling a price protection claim.

FIG. 12 is a flowchart of an example of a method for obtaining product data used in settling a price protection claim.

### DETAILED DESCRIPTION

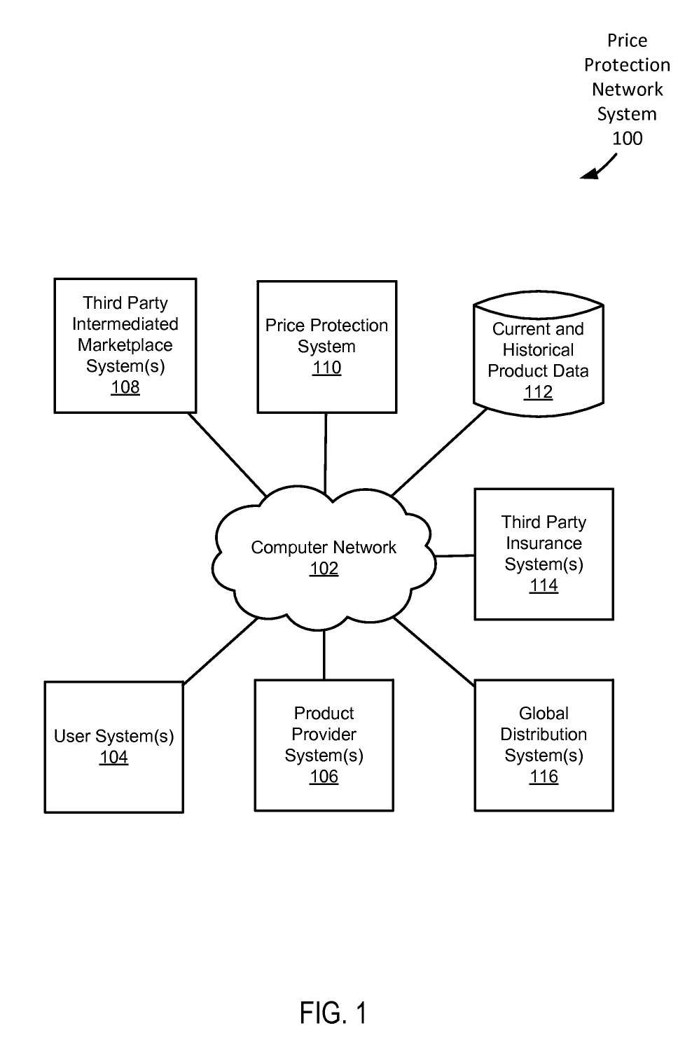

FIG. 1 is a block diagram of a price protection network system 100, according to some embodiments. The price protection network system 100 includes a user system 104, a product provider system(s) 106, a third party intermediated marketplace system(s) 108, a price protection system 110, a current and historical product data store 112, a third party insurance system 114, global distribution systems(s) 116, each coupled to a computer network 102.

The computer network 102 functions to transmit data between the user system 104, the product provider system 106, the third party intermediated marketplace system 108, the price protection system 110, the current and historical product data store 112, and the third party insurance system 114. The computer network 102 may include a medium that couples digital devices to one another. The computer network 102 may include technologies such as Ethernet, 802.11x, worldwide interoperability for microwave access WiMAX, 2G, 3G, 4G, CDMA, GSM, LTE, digital subscriber line (DSL), and/or the like. The computer network 102 may further include networking protocols such as multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and/or the like. Data exchanged over the computer network 102 may be represented using technologies and/or formats including hypertext markup language (HTML) and extensible markup language (XML). In addition, all or some links may be encrypted using conventional encryption technologies such as secure sockets layer (SSL), transport layer security (TLS), and Internet Protocol security (IPsec). Though element 102 is labeled a “computer network” in FIG. 1, it is noted that in various embodiments, the element 102 may refer to any medium that facilitates digital devices to other digital devices, or components of digital devices to other components of digital devices. In various embodiments, the element 102 may refer to a bus, cable, or other device used to couple components of a digital device to one another

The user system 104 functions to send and receive data used in shopping for and obtaining a price volatile, yield managed and perishable product. A product can include a tangible good and/or a service. Examples of price volatile, yield managed, and perishable products include a ticket on an airplane flight, a reservation in a hotel room, and a ticket to a concert or sporting event. A product is price volatile in that a price of the product fluctuates over time, often in unexpected ways (which can be based on a variety of market factors). A product is yield managed in that only a limited amount of a product (which may include products of a particular product class, fare, floor plan, quality, and/or the like) available to consumers. For example, if a product is a ticket on an airplane, the product is yield managed as there are only a specific number of tickets (or tickets of a particular class, view, size, floor plan, etc.) which can be sold. A product is perishable in that it will cease to exist in time, e.g., on a specific date or time. For example, if a product is a concert ticket, then the product is perishable in that it will cease to exist after the concert ends.

The user system 104 functions to send and receive data to obtain price protection of a price volatile, yield managed, and perishable product for a user. Price protection is a promise to cap the price of a price volatile, yield managed, and perishable product over a time period. Price protection is offered for products that a user has not purchased. The cap price may be the price of the product at the time when price protection was purchased. It need not be exactly the asking price (and can be higher or lower). For example, if a consumer purchases price protection of an airline ticket being offered at $400 for a three week period, the consumer will not have to pay more than $400 for the airline ticket, even if the price of the airline ticket goes up to $500. Price protection does not include a guarantee that the product will remain available during the time period.

In various embodiments, price protection can include an agreement between a user and a provider of the price protection, that if a user purchases price protection for a current product, and the user purchases an alternative current product offered to the user by the provider, then the provider is still obligated to fulfil the guarantee of the current product. For example, if a user purchases price protection for an airline ticket at $400 and purchases an alternative airline ticket offered to the user by a provider of the price protection, then the provider still guarantees the price protection for the airline ticket at $400.

In some embodiments, price protection can include an agreement between a user and a provider of the price protection that, if the user purchases an alternative current product, the price protection provider fulfills his obligation under the price protection contract. For example, if a user purchases price protection for an airline ticket at $600 and then purchases an alternative airline ticket at $400, then the price protection provider fulfilled their obligation.

In some embodiments, price protection can be specific to a class of a product. For example, if a user buys price protection for a seat in economy class of a flight, then price protection can be part of the agreement that any seat in economy class can be purchased at or about the price protected price. Price protection can also be part of an agreement that if a user purchases a product outside of a class of a product for which price protection is purchased, then the price protection provider fulfilled their obligations.

In some embodiments, if the consumer buys an alternative product at a price greater than the specific price, then (based on the contract terms) the price protection provider may or may not be obligated to pay the difference between the actual purchase price and the specific price. In some embodiments, the price protection provider may be obligated to pay the difference only if he offered the alternative product to the consumer.

In some embodiments, if a user purchases a product at a price greater than the specific price, then the price protection provider may owe the consumer the difference between the specific price and a lowest offered price at the time it was purchased (not the actual price of the product purchased). For example, if a user purchases price protection at $400 for a product now selling at $500 on a first site and at $600 on a second site, and if the price protection provider informs the user of the $500 price product but the user purchases the product from the second site at $600, then the price protection provider may owe the consumer only $100, not $200.

In some embodiments, price protection can include an agreement that if the price protected product sells out during the time period, then the price protection provider has to pay a penalty. A penalty can be a specific monetary amount (e.g., $400), a percentage of the specific price, a rewards program, a specific amount of rewards points for purchasing future product and/or price protection, and/or the like.

In some embodiments, a price protection provider may actively encourage a consumer to purchase the current product when the price protection provider recognizes the product is selling out, or may offer an alternative current product, possibly at discounted prices, to avoid the obligation of a penalty.

The user system 104 may reside on a mobile phone, a Personal Data Assistant (PDA), a tablet computing device, a laptop computer, a desktop computer, a thin client, an ultra-thin client or some combination thereof. The user system 104 may include a digital device that allows a user to interact with data used in obtaining either or both a product and price protection. The user system 104 may include a processor, e.g., a shared or dedicated processor configured to execute instructions loaded in memory. The processor may include a general purpose processor that executes an operating system, processes, and applications loaded into the memory. The processor may provide instructions to execute a network interface. The network interface may include hardware, firmware, and/or software configured to receive data from the computer network 102 and provide data to the computer network 102. The network interface may be compatible with the transmission protocols of the computer network 102 and other portions of the user system 104. The network interface may include a wireless interface through which the user system 104 may wirelessly send and receive data.

The product provider system 106 is a system of and/or a manager (e.g. travel agent) of a provider of a price volatile, yield managed, and perishable product. The product provider system 106 may function to provide product data/product specifications. Product data can include current product data for current products and historical product data for historical products. Product data comprises applicable information describing a product including: a location of a product, a provider of a product, a schedule of a product, an amount of a product available, and/or a price of a product. For example, if a product is an airline ticket, product data can describe departure and destination points of the flight, departure and arrival times of the flight, a number of seats available for the flight, the location on an airplane of available seats, and/or current prices of the available seats. In another example, if a product is a concert ticket, product data can describe a venue where the concert will be held, a start time, available seats at the concert, locations of available seats, and current prices.

Product data can include current product data for current products and historical product data for historical products. Current products include products that still exist, and historical products include products that no longer exist. For example, a historical product can include a flight between the same two cities that occurred in the past, possibly over the same calendar period in previous year. Historical product data can include current product data, such as the history of the prices of a currently available product.

The product provider system 106 may provide the current and historical product data to the price protection system 110, which it may store in the current and historical product data store 112.

The third party intermediated marketplace system 108 functions to provide a marketplace in which a user can shop for and purchase a price volatile, yield managed, and perishable product, often for a number of competing products from a number of different product providers. The third party intermediated marketplace system 108 is intermediated in that it acts as an intermediary between products from a product provider and a consumer. Examples of the third party intermediated marketplace system 108 include Expedia®, Travelocity®, Ticketmaster®, and StubHub®. The third party intermediated marketplace system 108 typically present products to a user based on product data received from one or more product provider system(s) 106. For example, if a product is an airline ticket, the third part intermediated marketplace system 108 may display flight information including the departure and arrival time and the departure city and destination. The third party intermediated marketplace system 108 can determine products to present to a user based on user queries, e.g., product preferences/constraints. For example, if user indicates that desire to travel to New York from San Francisco for the week of December 4 to December 11, then the third party intermediated marketplace system 108 can present various alternative flight options based on those preferences/constraints.

The third party intermediated marketplace system 108 functions to obtain relevant products. To identify the relevant products, the third party intermediated marketplace system 108 can communicate with one or more product provider system(s) 106 to obtain product options. In some embodiments, the third party intermediated marketplace system 108 can obtain the product on behalf of the user, e.g., can facilitate purchase and payment for the product. The third party intermediated marketplace system 108 can accept payment from the user and/or provide payment to the product provider system 106.

The price protection system 110 functions to offer and provide price protection services. The price protection system 110 can determine a price protection price for the product over the time period. The price protection system 110 can determine a price protection price in real time as a user views products through the third party intermediated marketplace system 108. The price protection system 110 can send price protection data, including price protection prices, to the third party intermediated marketplace system 108, which it uses to display price protection prices to the user. In some embodiments, the time period may be user selectable. The time period is a time period in which a user can exercise purchase price protection, e.g., a contract/expiration date/time after purchase of the price protection. In some embodiments, the time period may be selectable by the user, which may affect the price protection price. In some embodiments, the time period may be fixed.

In some embodiments, the price protection system 110 functions to communicate directly with a user system 104. The price protection system 110 can use a communication medium such as e-mail, short messaging service (hereinafter referred to as “SMS”), web portals, and price protection system specific applications existing locally on the user system 104. The price protection system 110 can inform a user about a price protected product and/or alternative current products. For example, if a price protected product is selling out, then the price protection system 110 can inform the user.

The price protection system 110 can function to enable settlement of a price protection claim. The price protection system 110 can determine whether a user has purchased the price protected product at a price greater or lesser than the price protected price or purchased an alternative current product at a price greater or lesser than the price protected price. The price protection system 110 can determine the settlement amount.

The price protection system 110 can function to communicate with one or more third party intermediated marketplace system(s) 108 and/or product provider system(s) 106. In some embodiments, the price protection system 110 can act as a proxy to third party intermediated marketplace system(s) 108 and product provider system(s) 106. The price protection system 110 can, at least in part, use the current and historical product data stored in the current and historical product data store 112 to determine a price protection price to offer the user.

The price protection system 110 may monitor price protected product prices and availability, current alternative product prices and availability and/or the like to determine whether to perform damage mitigation. The price protection system 110 can apply predictive modeling and/or machine learning to predict a future price and or availability of a product to determine whether to send product alerts and/or perform damage mitigation. The price protection system 110 may offer the user current alternative products at discounted prices to avoid penalties.

The price protection system 110 can monitor for user purchase of an alternative current product at a lesser price to recognize fulfillment of its obligations under the price protection contract. The price protection system 110 can monitor for user purchase of an alternative current product at a greater price to recognize settlement obligations. The price protection system 110 can monitor for selling out of the price protected product during the time period to recognize penalty obligations.

The price protection system 110 may actively monitor whether a price protected product is selling out to encourage a consumer to purchase the current product before it sells out or to decide whether to perform damage mitigation (e.g., offering the price protected product or an alternative current product at a discounted price). The price protection system 110 may monitor the price protected product price to determine whether to perform damage mitigation (e.g., offering the price protected product or an alternative current product at a discounted price).

In some embodiments, the price protection system 110 may hedge losses by contracting with a third party insurance system 114 to obtain insurance for price protections settlements made. The third party insurance system 114 can provide an overall insurance plan to the price protection system 110 or insurance on an individual price protection basis. For example, the price protection system 110 can provide a blanket insurance policy protecting the price protection system 110 against all losses over $400 or an individual policy for each price protection made by the price protection system 110.

The global distribution system(s) 116 function as part of a network through which a travel agent, the third party intermediated marketplace system 108 and/or the price protection system 110 can view current products and obtain current products. The price protection system 110 can collect current and historical product data from the global distribution system(s) 116. Examples of global distribution system(s) include Travelport®, Amadeus®, and Sabre®. The price protection system 110 may use the global distribution system(s) 116 to obtain historical and past pricing information and product data, verify product conversions, etc.

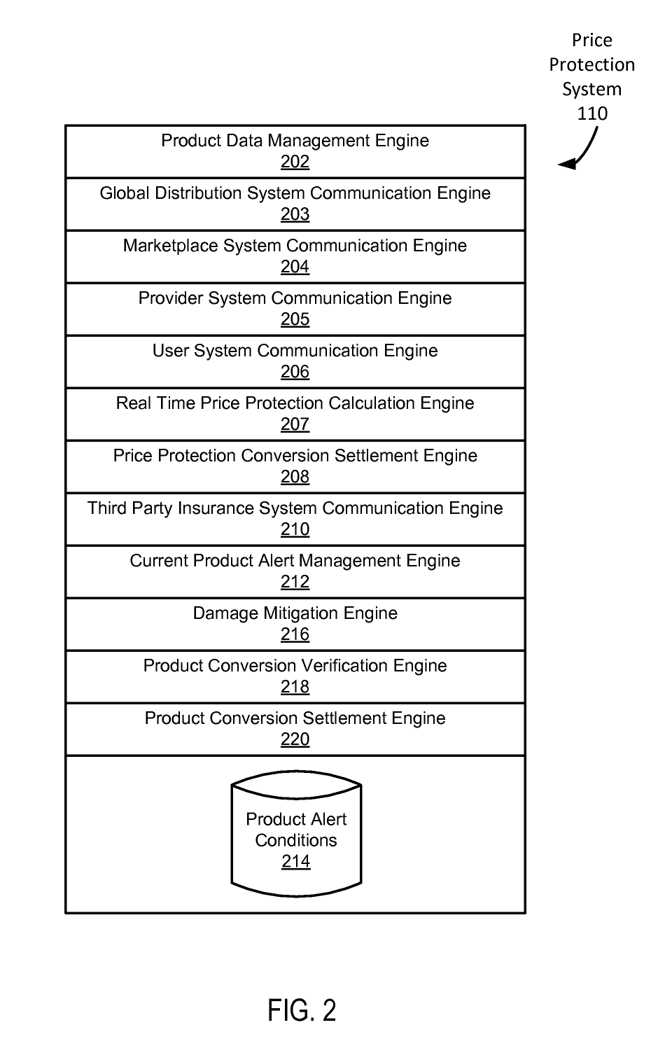

FIG. 2 depicts an example price protection system 110, according to some embodiments. The example price protection system 110 includes a product data management system 202, a global distribution system communication engine 203, a marketplace system communication engine 204, a provider system communication engine 205, a user system communication engine 206, a real time price protection calculation engine 207, a price protection conversion settlement engine 208, a third party insurance system communication engine 210, a current product alert management engine 212, a product alert conditions data store 214, a damage mitigation engine 216, a product conversion verification engine 218, and a product conversion settlement engine 220.

The product data management system 202 functions to manage the collection and storage of product data. The product data management system 202 can collect product data including either or both historical product data and current product data. Product data can be collected from either or both the product provider system 106 and the third party intermediated marketplace system 108. The product data management system 202 can separate collected product data into a historical product data and current product data. In some embodiments, the product data management system 202 communicates with the global distribution system(s) 116 to gather the product data.

The global distribution system communication engine 203 functions to send data to and receive data from the global distribution system(s) 116. For example, the global distribution system communication engine 203 may transmit product data requests and receive product data in return.

The marketplace system communication system 204 functions to send data to the third party intermediated marketplace system 108 to provide price protection data for products offered through the third part intermediated marketplace system 108. For example, if a user is looking at a specific product, then the marketplace system communication system 204 can send price protection data to the third intermediated marketplace system for displaying a price protection price in providing price protection for the specific product.

The marketplace system communication engine 204 functions to receive data from the third party intermediated marketplace system 108. In various embodiments, data received can include user interaction data, e.g., query parameters a user inputs when searching for a product, products viewed, products previously viewed, and/or the like. Data received may include a request to purchase price protection over a time period for a product at the specific price.

The provider system communication engine 205 functions to send data to and receive data from the product provider system(s) 106. For example, the provider system communication engine 205 may transmit product data requests and receive product data in return.

The user system communication engine 206 functions to send data to and receive data from the user systems 104. For example, the provider system communication engine 206 may transmit product conversion information requests and/or financial transaction requests and receive product conversion data and/or financial information in return.

The real time price protection calculation engine 207 functions to determine a price protection price. The real time price protection calculation engine 207 can function to determine a price protection price based on the current product data stored in the current and historical product data store 112, the historical product data stored in the current and historical product data store 112, and/or the time period. In other embodiments, the real time price protection calculation engine 207 will use predictive analysis and machine learning to determine the price protection price. The price protection calculation engine 207 can evaluate price volatility of the product, e.g., the likelihood that a price of a product will increase or decrease in the future, price volatility of alternative current products, etc. The price protection calculation engine 207 can determine a fulfilment risk of a product, e.g., the risk that the product will no longer be available during the time period. The real time price protection calculation engine 207 can use price volatility and fulfilment risk to determine the price protection price. For example, if a product has high price volatility and high fulfilment risk, then the real time price protection calculation engine 207 can raise the price protection price. Notably, price volatility and fulfilment risk may depend on when the time period occurs and/or the length of the time period.

In some embodiments, the real time price protection calculation engine 207 can determine a price protection price for a product using statistical analysis of either or both current product data and historical product data. For example, the real time price protection calculation engine 207 can determine a price protection price by evaluating either or both historical and current product trends determined through statistical analysis and/or predictive analysis. The real time price protection calculation engine 207 can determine a price protection price using machine learning. For example, the real time price protection calculation engine 207 can apply machine learning to current product data over time in developing models for determining price volatility and fulfilment risk.

The real time price protection calculation engine 207 can function to calculate price protection prices in real time as a user views or interacts with products through the third party intermediated marketplace system 108. The real time price protection calculation engine 207 can identify a current product that a user is interested in purchasing using the data received from the third party intermediated marketplace system 108.

The price protection conversion settlement engine 208 functions to manage conversion of a price protection offer. The price protection conversion settlement engine 208 can determine that a user wishes to purchase price protection for a given product over a given time period. The price protection conversion settlement engine 208 can receive payment for price protection from the user (possibly via the third party intermediated marketplace system 108) and appropriately distribute the payment to specific recipients. For example, the price protection conversion settlement engine 208 can provide a portion of payment to the third party intermediated marketplace system 108 provider, or otherwise allow the third party intermediated marketplace provider to keep a portion of the payment.

The third party insurance system communication engine 210 functions to communicate with the third party insurance system 114. The third party insurance system communication engine 210 can send and receive data to obtain third party insurance. The third party insurance system communication engine 210 can send price protection data to the third party insurance system 114 for use by the third party insurance system 114 to price the third party insurance. Price protection data can include numbers or price protections sold, the risk volatility and fulfilment risk of each, and/or the like. Price protection data can include more granular information including product identification, the price protected price, user identification, and/or the time period during which the price protection is provided.

The current product alert management engine 212 functions to manage current product alerts for the user. Product alerts can include price protected product information (e.g., current availability, anticipated availability, current price, anticipated price changes, etc.), current alternative product information (e.g., alternative product prices, alternative product anticipated prices, alternative product availability, anticipated alternative product availability, etc.), time period information, and/or product location information. For example, the current product alert management engine 212 can alert the user of the current price of the price protected product and/or the number of seats left on a flight. The current product alert management engine 212 can inform the user of the price and/or seat availability of alternative flights.

An alternative current product can be a product similar or equivalent to a price protected product. For example, if a user purchased price protection for a roundtrip flight from San Francisco to New York on United Airlines from December 4 to December 11, then an alternative current product can be alternative flights on different carriers from San Francisco to New York over the same or approximate date range. The current product alert management engine 212 can identify the alternative current products, e.g., based on data received from the third party intermediated marketplace system(s) 108 and/or product provider system(s) 106.

The current product alert management engine 212 can function to send product alerts based on product alert conditions stored in the product alert conditions data store 214. Product alert conditions can specify the circumstances when to send product alerts. Example circumstances can involve the price protected product price, the price protected product availability, price volatility, fulfilment risk, etc. A product alert condition can be sent when the price of the price protected product increases above a threshold amount. A product alert condition can specify to send an alert when the price or availability of alternative current products fall below a threshold amount. A product alert condition can specify to send an alert when the fulfilment risk increases above a threshold amount. Other product alert condition options exist.

The current product alert management engine 212 can add, cancel and/or modify product alert conditions stored in the product alert conditions data store 214. In some embodiments, the current product alert management engine 212 can add, cancel and/or modify product alert conditions based on machine learning based on macro behavior of a large population of users or micro behavior of a small population or single user. For example, if machine learning indicates that a user is more likely to purchase an alternative current product if the alternative current product is an earlier flight time than a current price protected product, then the current product alert management engine 212 can update the product alert conditions to specify sending product alerts for alternative current products with earlier flight times than a current price protected product.

The current product alert management engine 212 may send the product alerts by any means of communication, such as email, SMS, telephone calls, push notifications, in-application notifications, etc.

The damage mitigation engine 216 functions to determine whether damage mitigation should be performed for a current price protected product. Damage mitigation, can include offering an alternative current product to a user at a discounted price (e.g., lower than the current price of the alternative current product) or adding a purchase incentive. For example, if the price protected price is $400, then an alternative current product can be offered at a reduced price of $350 to avoid a penalty (should the price protected product sell out) or to avoid a larger loss (should the price of the price protected product have increased more than the difference between the actual and the discounted price of the alternative current product). Examples of purchase incentives include rebates, free services, gift certificates, upgrades, and/or money.

In some embodiments, the damage mitigation engine 216 can determine whether to perform damage mitigation by evaluating risk level, namely, the risk that a greater loss is likely to occur unless an alternative occurs.

In some embodiments, the damage mitigation engine 216 functions to offer alternative current products to a user at a price that decreases monetary damage to a price protection provider caused by price protection. The damage mitigation engine 216 can offer alternative current products to a user at a price reduction less than a difference between the specific product price at which a product is price protected and a current price of the product. For example, if a flight is price protected at $400 and the current price of the flight is $800, and an alternative flight has a current price of $600, then the damage mitigation engine 216 can offer the alternative flight at a reduced price of $250. The damage mitigation engine 216 can offer alternative current products to a user at a price reduction less than a penalty owed by a provider of price protection if a current price protected product sells out. For example, if a penalty is $400 for a sold out price protected first flight, and an alternative flight has a current price of $600, then the damage mitigation engine 216 can offer the alternative flight for $250.

The damage mitigation engine 216 can determine whether to perform damage mitigation for a current price protected product based on one or a combination of a current price of a current product, a current availability of a current product, and a risk level of the price protection. In various embodiments, the damage mitigation engine 216 can determine whether to perform damage mitigation for a current price protected product based on a current availability of the current price protected product, a current price of the price protected product, a current availability of alternative current products, and/or a current price of alternative current products. For example, if a current price of a current price protected product increases above a specific amount, or a difference between a guaranteed price according to the price protection and the current price protected product increases above a certain amount, then the damage mitigation engine 216 can determine to perform damage mitigation. In determining whether to perform damage mitigation for a current price protected product, the damage mitigation engine 216 can determine a risk level of the price protection of the product. As used in this paper, a risk level is a chance that a provider of price protection will lose money in providing the price protection. A risk level can be based on a price volatility and/or a fulfilment risk for a product.

The product conversion verification engine 218 functions to determine if a user has purchased the price protected product or an alternative current product. The product conversion verification engine 218 can determine the purchase price, possibly by communicating with the third party intermediated marketplace system(s) 108 and the product provider system(s) 106.

The product conversion settlement engine 220 functions to manage settlement of a product conversion. The product conversion settlement engine 220 can determine if a settlement is owed, can determine to whom the payment is owed, and can determine the amount owed. For example, the product conversion settlement engine 220 can determine whether payment is owed to the user, to a third party intermediated marketplace system 108, or to a product provider system 106. The product conversion settlement engine 220 can determine the amount owed based on the price protected price and the actual price.

In some embodiments, as noted above, the product conversion settlement engine 220 can determine the amount owed based on a lowest price available at the time of actual purchase (e.g., in some embodiments, only if the user was informed of the opportunity or had access to the lowest price through the price protected system 110). The product conversion settlement engine 220 can determine a difference between the lowest price available when purchased and the price protected price. In some embodiments, the price conversion settlement engine 220 may need to obtain the single lowest price of the price protected product. In an embodiment where the price protected product is an airline ticket, the price conversion settlement engine 220 may request this information from the global distribution system(s) 116 or product provider system 106, possibly using the identifier. For example, the price conversion settlement engine 220 can query the global distribution system(s) 116 with a travel agent code and/or a flight designator of a flight to retrieve data indicating a single lowest airfare of the flight of a particular class.

The product conversion settlement engine 220 can function to facilitate payment of a price protection claim based on an amount owed to the entity owed. In facilitating payment, the product conversion settlement engine 220 can provide payment to a user in an amount that is owed to them or instruct an external system to provide payment to the user. For example, the product conversion settlement engine 220 can instruct Paypal® to deposit an amount owed to a user into an account of the user. In another example, the product conversion settlement engine 220 can wire payment owed to a user directly into an account of the user. Further, the product conversion settlement engine 220 can instruct the product provider system 106, the third party intermediated marketplace system 108, and/or the global distribution system 116 to pay an amount of payment owed to a user based on a price protection claim and/or offer and accept payment of the product to the user based on the amount of payment owed to the user based on the price protection claim.

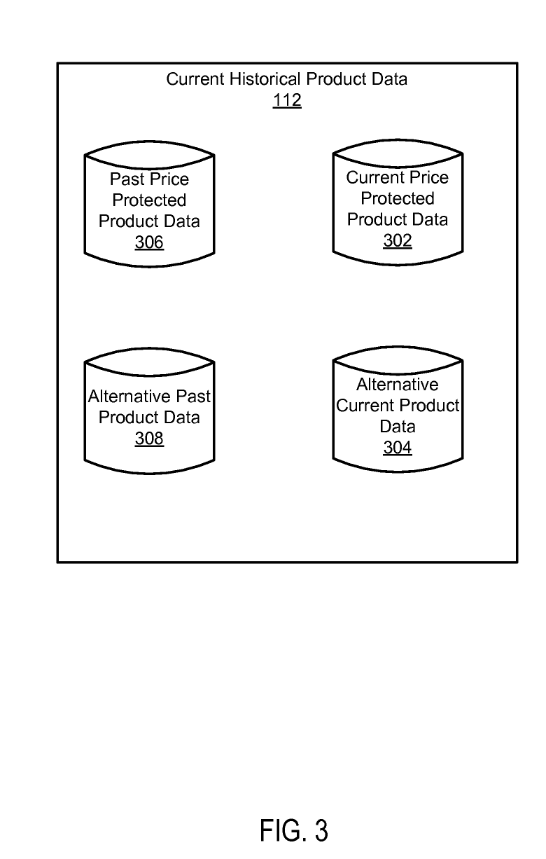

FIG. 3 depicts an example current and historical product data store 112, according to some embodiments. The example current and historical product data store 112 includes a current price protected product data store 302, an alternative current product data store 304, a past price protected product data store 306, and an alternative past product data store 308.

The current price protected product data store 302 functions to store current price protected product data, included as part of current product data, of current price protected products. Current price protected product data comprises applicable information describing a current price protected product including: a location of a current price protected product, a provider of a current price protected product, a schedule of a current price protected product, an amount of a current price protected product available, and/or a price of a current price protected product. The current price protected product data store 302 can store current price protected product data collected by the price protection system 110 from either or both the third party intermediated marketplace system(s) 108 and the product provider system(s) 106. Current price protected product data can be used to determine a price protection price for a product, managing third party insurance of price protection, sending of product alerts to a user, and/or the settlement of purchased products based on a price protected product.

The alternative current product data store 304 functions to store alternative current product data, included as part of current product data, of alternative current products. Alternative current product data comprises applicable information describing alternative current products including: alternative current product locations, alternative current product providers, alternative current product schedules, alternative current product availability, and/or alternative current product prices. The alternative current product data store 304 can store alternative current product data collected by the price protection system 110 from either or both the third party intermediated marketplace system(s) 108 and the product provider system(s) 106. Alternative current product data can be used to determine a price protection price for a product, managing third party insurance of price protection, sending of product alerts to a user, and/or the settlement of purchased products based on a price protected product.

The past price protected product data store 306 functions to store past price protected product data, included as part of past product data, of past price protected products. Past price protected product data comprises applicable information describing past price protected products including: past price protected product locations, past price protected product providers, past price protected product schedules, past price protected product availability, and/or past price protected product prices. The past price protected product data store 306 can store past price protected product data collected by the price protection system 110 from either or both the third party intermediated marketplace system(s) 108 and the product provider system(s) 106. Past price protected product data can be used to determine a price protection price for a product, managing third party insurance of price protection, sending of product alerts to a user, and/or the settlement of purchased products based on a price protected product.

The alternative past product data store 308 functions to store alternative past product data, included as part of past product data, of alternative past products. Alternative past product data comprises applicable information describing alternative past products including: alternative past product locations, alternative past product providers, alternative past product schedules, alternative past product availability, and/or alternative past product prices. The alternative past product data store 308 can store alternative past product data collected by the price protection system 110 from either or both the third party intermediated marketplace system(s) 108 and the product provider system(s) 106. Alternative past product data can be used to determine a price protection price for a product, managing third party insurance of price protection, sending of product alerts to a user, and/or the settlement of purchased products based on a price protected product.

Although not shown, one skilled in the art will recognize that the data store may include other data and that may be categorized differently. The data store 112 may include a general data training set, past price protected product data, current price protected product data, simulated past price protected product data (for model accuracy testing purposes, used to optimize pricing and mitigate risk while pricing), current price protected product data on simulated price protections, alternative past product data, and/or alternative current product data.

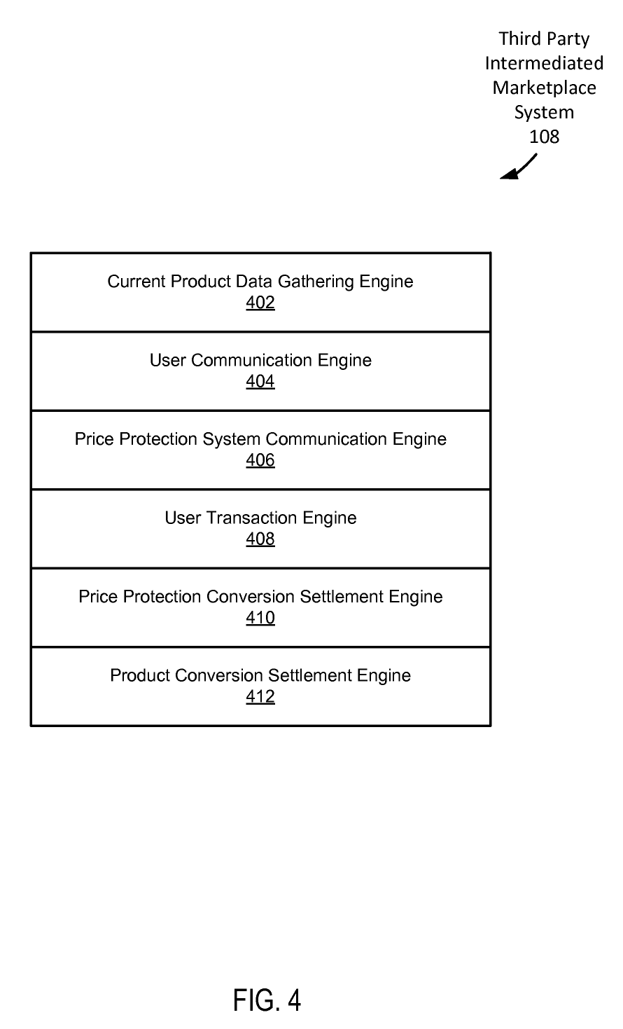

FIG. 4 depicts an example third party intermediated marketplace system 108, according to some embodiments. The example third party intermediated marketplace system 108 includes a current product data gathering engine 402, a user communication engine 404, a price protection system communication engine 406, a user transaction engine 408, a price protection conversion settlement engine 410 and a product conversion settlement engine 412.

The current product data gathering engine 402 functions to gather product data of current products. The current product data gathering engine 402 can gather product data of either or both current price protected products and alternative current products. The current product data gathering engine 402 can gather product data of current products from the product provider system(s) 106 or possibly other third party intermediated marketplace system(s) 108.

The user communication engine 404 functions to send data to and receive data from the user system 104 in allowing a user to interact with the third party intermediated marketplace system 108 for purchasing a product and/or price protection. The user communication engine 404 can use product data collected by the current product data gathering engine 402 to display currently available products to a user. Further, the user communication engine 404 can use received price protection data to present price protection prices of products to users. The user communication engine 404 can receive user input regarding price protection and/or a product. Further, the user communication engine 404 can receive payment data for performing product conversion and/or price protection conversion settlements.

The price protection system communication engine 406 functions to send data to and receive data from the price protection system 110. The price protection system communication engine 406 can send data from the third party intermediated marketplace system 108 to the price protection system 110 for use in providing price protection to a user. For example, the price protection system communication engine 406 can send user interaction data for determining in real time price protection prices of products a user is viewing in real time. The price protection system communication engine 406 can receive price protection data from the third party intermediated marketplace system 108 used in displaying price protection prices for products.

The user transaction engine 408 functions to manage transactions for a user in obtaining a product and/or price protection for a product. The user transaction engine can determine if a user wishes to purchase a product and/or a price protection for a product. The user transaction engine 408 can function to obtain a product or price protection a user wants. For example, if the user wishes to purchase a product, then the user transaction engine 408 can purchase the product for the user. In various embodiments, if the user transaction engine 408 determines that a user wants to purchase price protection for a product, then the user transaction engine 408 can instruct the price protection system communication engine 406 to send data to the price protection system 110 indicating that the user wishes to purchase the price protection.

In some embodiments, the price protection conversion settlement engine 410 functions to manage settlement of price protection a user purchases. In managing price protection conversion settlement, the price protection conversion settlement engine 410 can instruct the user price system communication engine 406 to send payment or information facilitating payment, e.g. a credit card number, to the price protection system 410, Further in managing price protection conversion settlement, the price protection conversion settlement engine 410 can obtain a portion of a payment of a price protection price, as instructed by the price protection system 110. For example, if the third party intermediated marketplace provider should receive a flat rate or a percentage of a price protection price for provided price protection, then the price protection conversion settlement engine 410 can facilitate collecting payment of the price protection price using payment information received from a user.

The product conversion settlement engine 412 functions to manage settlement of a product a user purchases. The product conversion settlement engine 412 can determine to whom payment is owed and the amount owed. For example, the product conversion settlement engine 412 can determine the provider amount owed to a product provider. In various embodiments, the product conversion settlement engine 412 can send the provider amount to a provider. Further, the product conversion settlement engine 412 can determine the amount owed to the third party intermediated marketplace provider and facilitate retaining the amount for the marketplace provider.

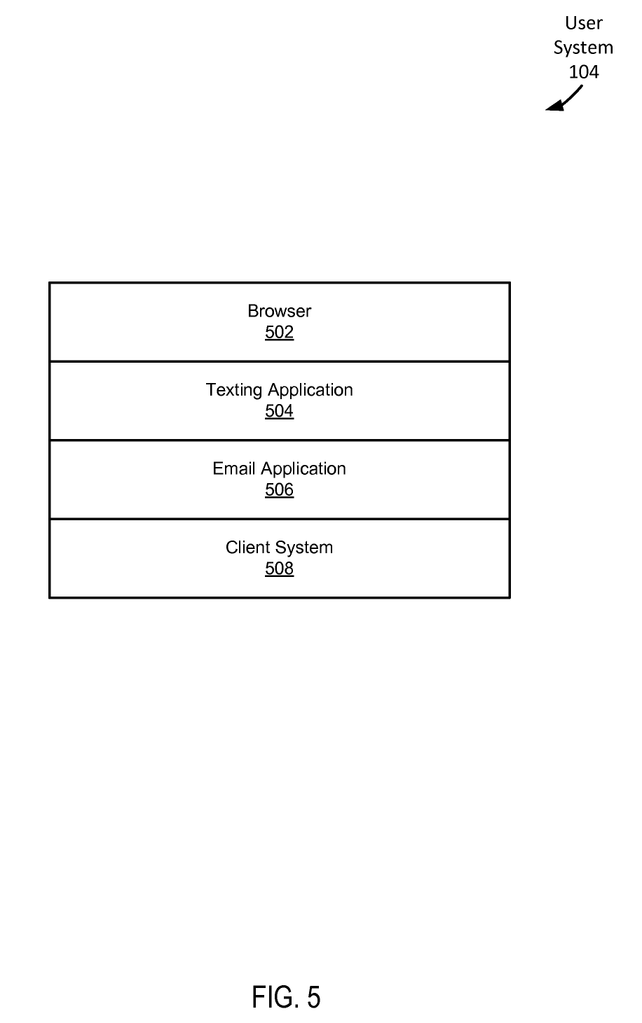

FIG. 5 depicts an example user system 104, according to some embodiments. The example user system 104 includes a browser 502, a texting application 504, an email application 506, and a client system 508.

The browser 502 functions to provide a web portal through which the user system 104 can send and receive data through the computer network 102. The browser 502 can send data to and receive data from the product provider system(s) 106, the third party intermediated marketplace system(s) 108, and/or the price protection system 110. The browser 502 can be used to send and receive data used in viewing products and price protection prices for products, purchasing a product, and/or purchasing price protection for a product. In various embodiments, the browser 502 can be used to receive product alerts (e.g., from the price protection system 110).

The texting application 506 functions to provide a portal through which the user system 104 can send and receive text data. The texting application 506 can send text data to and receive text data from the product provider system(s) 106, the third party intermediated marketplace system(s) 108, and/or the price protection system 110. The texting application 504 can be used to send and receive text data used in viewing products and price protection prices for products, purchasing a product, and/or purchasing price protection for a product. In various embodiments, the texting application 504 can be used to receive product alerts (e.g., from the price protection system 110).

The email application 506 functions to provide a portal through which the user system 104 can send and receive emails. The email application 506 can send and receive emails from the product provider system(s) 106, the third party intermediated marketplace system(s) 108, and/or the price protection system 110. The email application 506 can be used to send and receive emails used in viewing products and price protection prices for products, purchasing a product, and/or purchasing price protection for a product. In various embodiments, the email application 506 can be used to receive product alerts (e.g., from the price protection system 110).

The client system 508 functions as an application residing at the user system 104 through which data can be sent and received. The client system 508 can be used to send data to and receive data from the product provider system(s) 106, the third party intermediated marketplace system(s) 108, and/or the price protection system 110. The client system 508 can be used to send and receive data for viewing products and price protection prices for products, purchasing a product, and/or purchasing price protection for a product. In various embodiments, the client system 508 can be used to receive product alerts (e.g., from the price protection system 110).

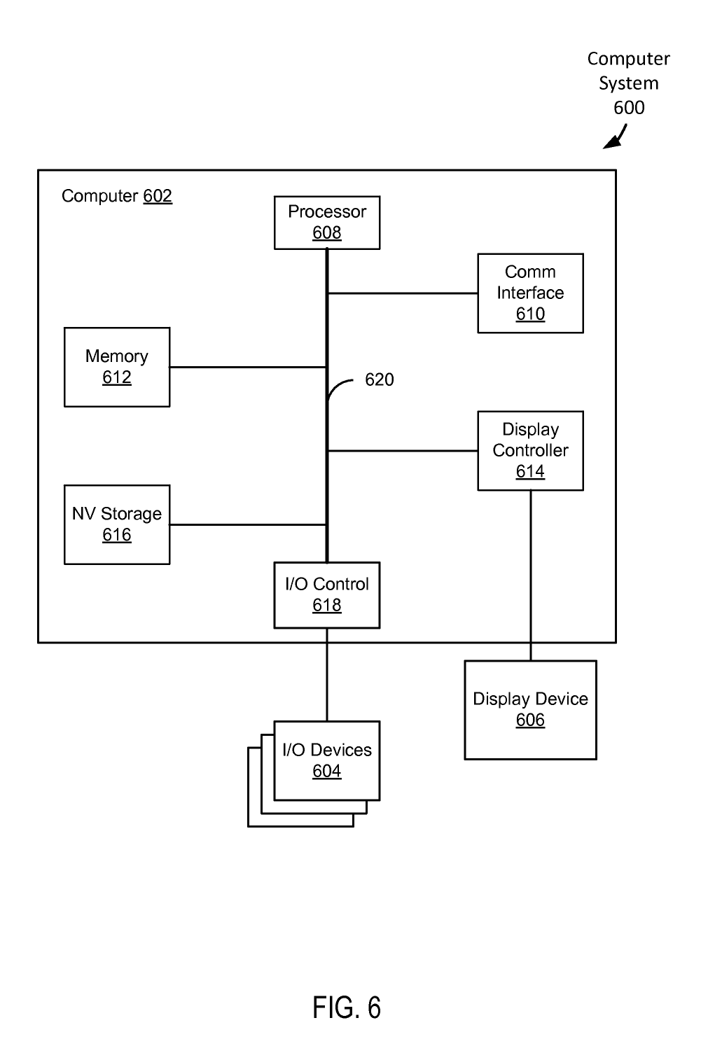

FIG. 6 depicts an example computer system 600, according to some embodiments. The computer system 600 can be used to implement at least in part the systems and engines described herein. The computer system 600 can be a conventional computer system, such as a wired or wireless client or a workstation, or a server computer system. The computer system 600 includes a computer 602, I/O devices 604, and a display device 606. The computer 602 includes a processor 608, a communications interface 610, memory 612, display controller 614, non-volatile storage 616, and an I/O controller 618. The computer 602 may be coupled to or include the I/O devices 604 and display device 606.

The computer 602 interfaces to external systems through the communications interface 610, which may include a modem or network interface. The communications interface 610 can be an analog modem, ISDN modem, cable modem, token ring interface, satellite transmission interface (e.g. “direct PC”), or other interfaces for coupling a computer system to other computer systems.

The processor 608 may be, for example, a conventional microprocessor such as an Intel Pentium microprocessor or Motorola power PC microprocessor. The processor 608 can be, for example, a general-purpose central processing unit (CPU), such as a microprocessor, or a special-purpose processor, such as a microcontroller. The memory 612 is coupled to the processor 608 by a bus 620. The memory 612 can be Dynamic Random Access Memory (DRAM) and can also include Static RAM (SRAM). The bus 620 couples the processor 608 to the memory 612, also to the non-volatile storage 616, to the display controller 614, and to the I/O controller 618.

The I/O devices 604 can include a keyboard, disk drives, printers, a scanner, and other input and output devices, including a mouse or other pointing device. The display controller 614 may control in the conventional manner a display on the display device 606, which can be, for example, a cathode ray tube (CRT) or liquid crystal display (LCD). The display controller 614 and the I/O controller 618 can be implemented with conventional well-known technology.

The non-volatile storage 616 is often a magnetic hard disk, an optical disk, or another form of storage for large amounts of data. Some of this data is often written, by a direct memory access process, into memory 612 during execution of software in the computer 602. One of skill in the art will immediately recognize that the terms “machine-readable medium” or “computer-readable medium” includes any type of storage device that is accessible by the processor 608 and also encompasses a carrier wave that encodes a data signal.

The computer system 600 is one example of many possible computer systems that have different architectures. For example, personal computers based on an Intel microprocessor often have multiple buses, one of which can be an I/O bus for the peripherals and one that directly connects the processor 608 and the memory 612 (often referred to as a memory bus). The buses are connected together through bridge components that perform any necessary translation due to differing bus protocols.

Network computers are another type of computer system that can be used in conjunction with the teachings herein. Network computers need not include a hard disk or other mass storage, and the executable programs may be loaded from a network connection into the memory 612 for execution by the processor 608.

Memory can be local, remote, or distributed. The “computer-readable storage medium” is intended to include only physical media, such as memory. Known statutory computer-readable mediums include hardware (e.g., registers, random access memory (RAM), non-volatile (NV) storage, to name a few), but may or may not be limited to hardware.

The bus can also couple the processor to the non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Notably, for some programs, it may not be possible to store the entire program in the memory. It should be understood that, for such software to run, it may need to be moved to a computer-readable location appropriate for processing. For example, the location is referred to as the memory. A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

Several components described herein can be compatible with or implemented using a cloud-based computing system. In some embodiments, a cloud-based computing system provides computing resources, software, and/or information to client devices by maintaining centralized services and/or resources that client devices can access over a communication interface, such as a network. The cloud-based computing system can involve a subscription for services or use a utility pricing model. Users can access the protocols of the cloud-based computing system through a web browser or other container application located on their client device.

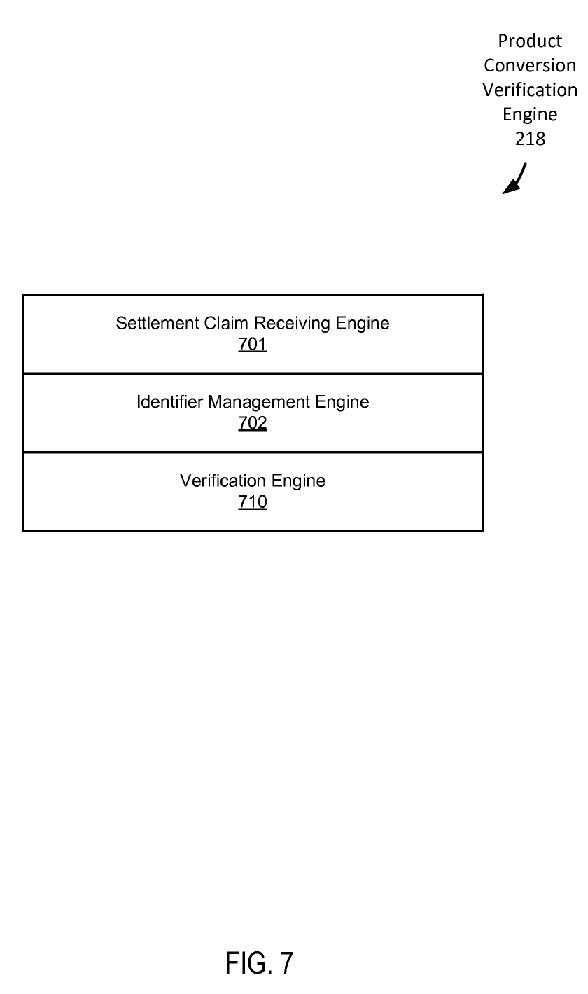

FIG. 7 depicts the product conversion verification engine 218, according to some embodiments. The product conversion verification engine 218 includes a settlement claim receiving engine 701, an identifier management engine 702, and a verification engine 710.

The settlement claim receiving engine 701 receives a settlement claim. In some embodiments, the settlement claim is received from the user. The settlement claim may be automatically received from the third party intermediated marketplace system 108, the product provider system 106 or the price protection system 110. In some embodiments, the settlement claim includes verification items (described below), and/or identifiers of verification items.

The identifier management engine 702 functions to manage identifiers used in obtaining product data. An identifier can uniquely identify a product, including current and historical products, and/or a user. When the product is an airline ticket, an identifier can be a passenger name record assigned to a user, a travel agent code, a flight number, an international air transport airline (hereinafter referred to as “IATA”) designator, a flight designator, an IATA destination airport code, and/or an IATA departure airport code. The identifier management engine 702 can add, update, and/or retrieve identifiers to and from a data store. One or more identifiers can be used in the retrieval of product data.

The verification engine 710 operates to verify a price protected product conversion. In some embodiments, the verification engine 710 has a checklist of items to verify a price protected product conversion, such as flight, purchase information, product specifications, passenger name, a purchase date/time, a lowest price of the product at the time of purchase, etc. In some cases, the items to verify the price protected product conversion can be obtained via the global distribution system(s) 116, the product provider system(s) 106, and/or the third party intermediated marketplace system(s) 108. In such case, the verification engine 710 may request the information from these systems. In other cases, these other systems may send the information automatically to the price protection system 110.

In one embodiment, the user may purchase the price protected product from the third party intermediated marketplace system 108 from which it purchased the price protection. In another embodiment, the user may purchase the price protected product through the price protection system 110 itself. In another embodiment, the user may purchase the price protected product from a third party intermediated marketplace system 108 different than the one from which it bought the price protection but which is configured with the systems described herein. In each of these cases, the price protection system 110 can be easily made aware by a trusted source, namely, itself or a trusted third party intermediated marketplace system 108, of the purchase of the price protected product. The trusted source is capable of providing all of the items needed to verify the price protected product conversion, and thus the trusted source can determine the settlement amount, if any, and to whom the settlement is owed. In some embodiments, the trusted source may provide the items in real time, as a user purchases the price protected product.

In another embodiment, the user may purchase the price protected product from a meta-search website. Meta-search websites simply redirect a user to the third party intermediated marketplace system(s) 108 or product provider system(s) 106 to purchase the product. In some embodiments, instead of simply redirecting from “metasite.com” to “providersite.com” in the client's web browser, the system may use a proxy to route all traffic. The proxy can be part of the price protection system 110 to gather the pages a user visits on the “providersite.com” website after being redirected from “metasite.com”. In turn, the verification engine 710 can verify whether a purchase occurred once the user reaches the purchase confirmation page (and can gather verification items that can be read from that page).

In another embodiment, the user may purchase the price protected product from another party, e.g., from a travel agent, from a product provider system 106 or third party intermediated marketplace system that is not configured with the systems described herein, etc. In such a case, the verification engine 710 may need to obtain items of information from the user and may need to verify the conversion with a trusted entity, e.g., with the product provider system 106 and/or global distribution system 116.

The verification engine 710 may request items of information from the user, e.g., a copy of a purchase record, a unique identifier, a product identifier, a confirmation number, and/or other information. The items of information requested from the user may include items on the verification checklist or items that assist the verification engine 710 to obtain the verification items. In some embodiments, the verification engine 710 can use the items of information to query various resources, e.g., the global distribution system(s) 116 and/or product provider system(s) 106 for the verification items to verify the user's claim. Upon verification, the verification engine 710 may inform the product conversion settlement engine 220 that a settlement claim has been verified.

Notably, the verification engine 710 can use combinations of the above embodiments, such as gathering what it can from trusted sources, and then asking the user for more verification items as needed.

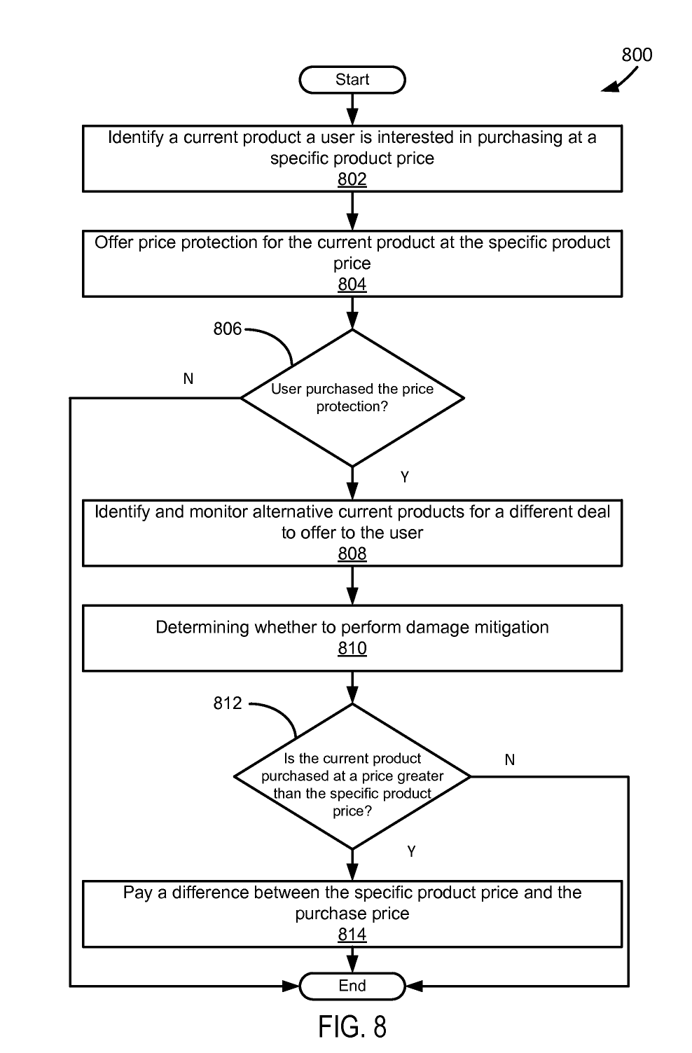

FIG. 8 is a flowchart of an example of a method 800 for providing price protection for a price volatile, yield managed, and perishable product. It is noted the steps in FIG. 8 are by way of illustration only, and that the method 800 may include elements not explicitly depicted, and that all elements are not necessary to perform the method 800.

At step 802, a current product a user is interested in purchasing at a specific product price is identified. The current product data can be provided from the third party intermediated marketplace system 108 to the real time price protection calculation engine 207.

At step 804, price protection for the current product at the specific price for a time period is offered. Price protection can be offered for a price protection price as determined by the real time price protection calculation engine 208 in real time. The price protection price can be determined by the real time price protection calculation engine 208 based on price volatility of the current product, fulfilment risk of the current product, the time period, alternative current products available, anticipated alternative current product prices, etc.

At decision point 806, it is determined whether the user purchased the price protection. The price protection conversion settlement engine 208 can determine whether a user wishes to purchase and does in fact purchase the price protection based on user input regarding price protection from the third party intermediated marketplace system 108. If it is determined that the user purchase the price protection, then the method 800 continues to step 808. Otherwise, method 800 ends.

At step 808, alternative current products are monitored for identifying a potential different deal to offer the user. Alternative current products can be identified and monitored by the current product alert management engine 212 using product data collected by the product data management system 202.

At step 810, it is determined whether to perform damage mitigation. A damage mitigation engine 216 can determine whether to perform damage mitigation based on a current price of the current product, current availability of the current product, and/or a risk level of the price protection for the current product, etc.

At decision point 812, it is determined if the current product is purchased by the user at a price greater than the specific product price included as part of the price protection. A product conversion verification engine 218 can determine if the current product is purchased at a price greater than the specific product price. If it is determined that the current product is purchased at a price greater than the specific product price, then the method 700 continues to step 814. If not, then method 800 ends.

At step 814, a difference between the specific product price and the actual purchase price is determined and paid to the appropriate entity. The product conversion settlement engine 220 can pay the difference between the specific product price and the purchase price. The product conversion settlement engine 220 can determine the amount of money to be paid, and the entity to pay.

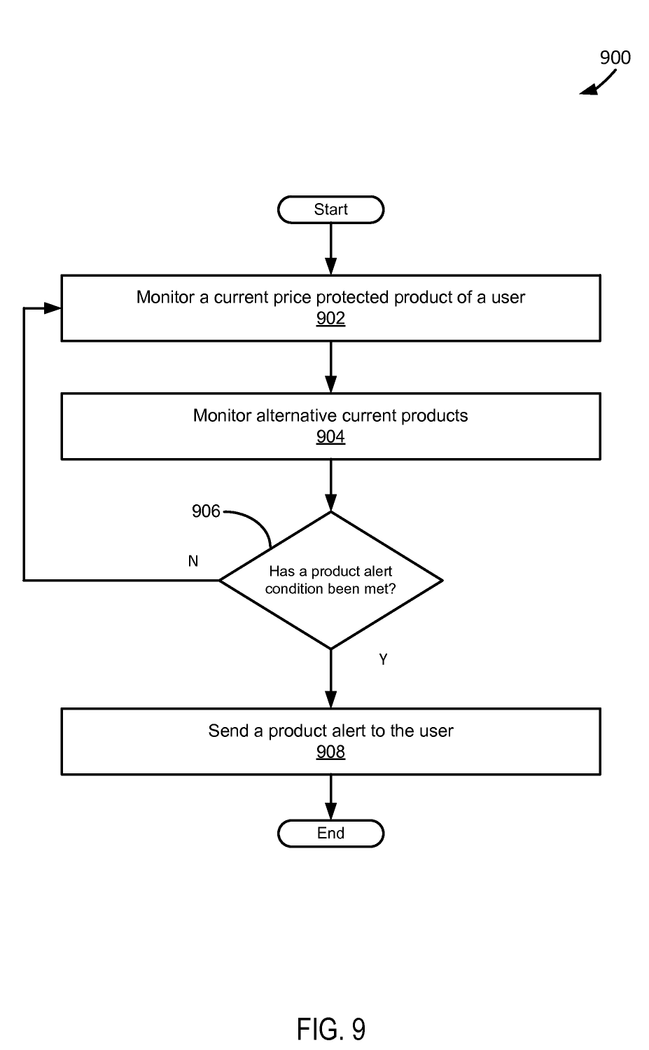

FIG. 9 is a flowchart of an example of a method 900 for sending product alerts to a user as part of providing price protection. It is noted the steps in FIG. 9 are by way of illustration only, and that the method 900 may include elements not explicitly depicted, and that all elements are not necessary to perform the method 900.

At step 902, a current price protected product is monitored. The current product alert management engine 212 can monitor the current price protected product. The current product alert management engine 212 can track the current price of the price protected product, current availability of the price protected product, predicted prices of the price protected product, predicted changes of the price protected product, predicted availability of the price protected product, and/or predicted changes in the availability of the price protected product.

At step 904, alternative current products are monitored. The current product alert management engine 212 can monitor the alternative current products. The current product alert management engine 212 can track current prices of the alternative current products and/or current availabilities of the alternative current products.

At decision point 906, it is determined if a product alert condition has been met. The current product alert management engine 212 can determine if a product alert condition has been met according to various data points, e.g., price and availability of the current price protected product and/or the prices and availabilities of alternative current products. For example, if a current price of the price protected product increases above a certain amount and a product alert condition specifies the circumstance that the current price of the protected product increases above the certain amount, then a product alert condition may have been met. If it is determined at decision point 906 that the product alert condition has been met, then the method 900 continues to module 908. Otherwise, the method 800 returns to step 902.

At module 908, a product alert is sent to the user according to the product alert condition. The current product alert management engine 212 can send the product alert to the user through any communication channel, e.g., text, email, phone, browser, etc. The product alert can include information related to a current price and/or current availability of current products, e.g., the current price protected product and/or the alternative current products.

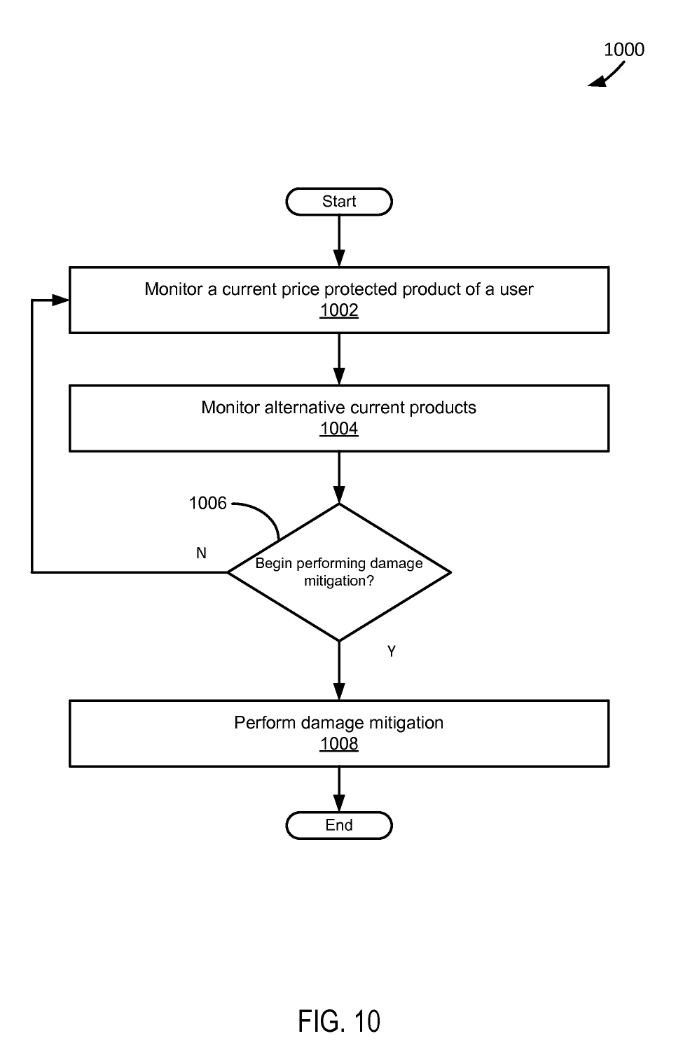

FIG. 10 is a flowchart of an example of a method 1000 for performing damage mitigation in providing price protection. It is noted the steps in FIG. 10 are by way of illustration only, and that the method 1000 may include elements not explicitly depicted, and that all elements are not necessary to perform the method 1000.

At step 1002, a current price protected product is monitored. The current product alert management engine 212 can monitor the current price protected product. The current product alert management engine 212 can track a current price and/or current availability of the current price protected product.

At step 1004, alternative current products to the current price protected product are monitored. The current product alert management engine 212 can monitor the alternative current products. The current product alert management engine 212 can track current prices and/or current availabilities of the alternative current products.

At decision point 1006, it is determined whether to perform damage mitigation for the price protection of the current price protected product. A damage mitigation engine 216 can determine whether to perform damage mitigation based on the current prices and/or availabilities of the price protected product and/or the alternative current products. If it is determined at decision point 1006 to begin performing damage mitigation, then the method continues to step 1008. Otherwise, method 1000 returns to step 1002.

At step 1008, damage mitigation is performed. The damage mitigation engine 216 can send data used in performing damage mitigation to the user system 104 and/or the third party intermediated marketplace system 108. For example, the damage mitigation engine 216 can send discounted offers and/or purchase incentives to the user system 104 in performing damage mitigation.

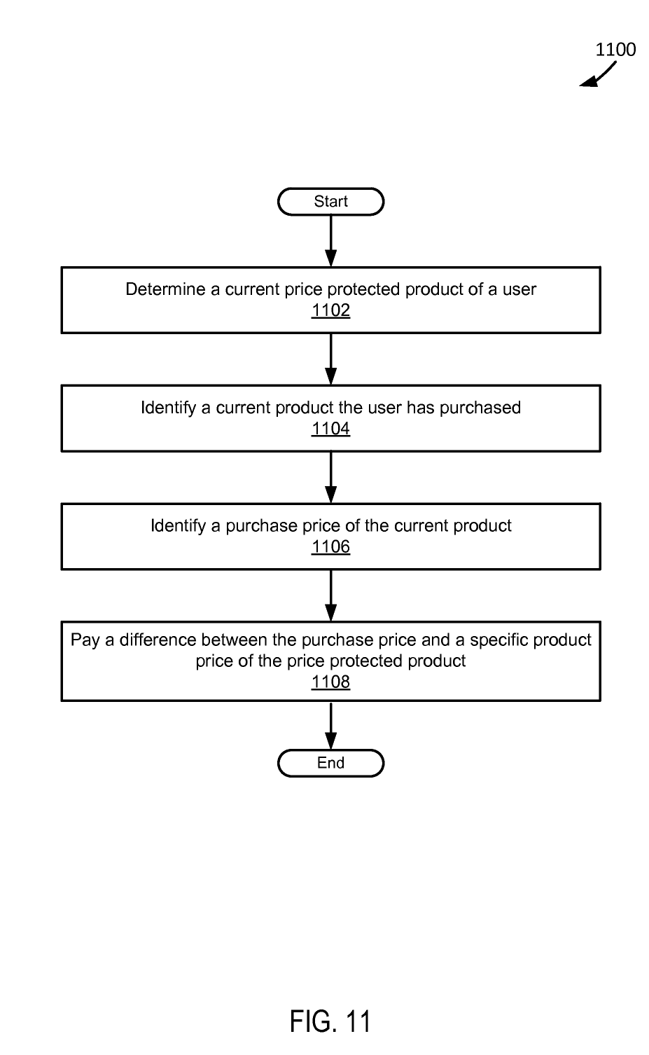

FIG. 11 is a flowchart of an example of a method 1100 for settling a price protection claim. It is noted the steps in FIG. 11 are by way of illustration only, and that the method 1100 may include elements not explicitly depicted, and that all elements are not necessary to perform the method 1100.

At step 1102, a current price protected product is determined. The price protection conversion settlement engine 208 can determine the current price protected product.

At step 1104, a purchased current product is identified. The product conversion verification engine 218 can determine the purchased current product using the third party intermediate marketplace system 108 and/or the product provider system 106. Notably, the purchased current product can be the current price protected product or an alternative current product.

At step 1106, a purchase price at which the user purchased the purchased current product is determined. The product conversion verification engine 218 can determine the purchase price of the current product using the third party intermediated marketplace system 108 and/or the product provider system 106.

At step 1108 the price protection claim is settled, e.g., by paying a difference between the purchase price and the specific product price of the price protected product, with the appropriate entity. The product conversion settlement engine 220 can pay the difference between the purchase price and the specific product price of the price protected product. The settlement can be paid to the user, a product provider, the third party intermediated marketplace provider and/or the like.

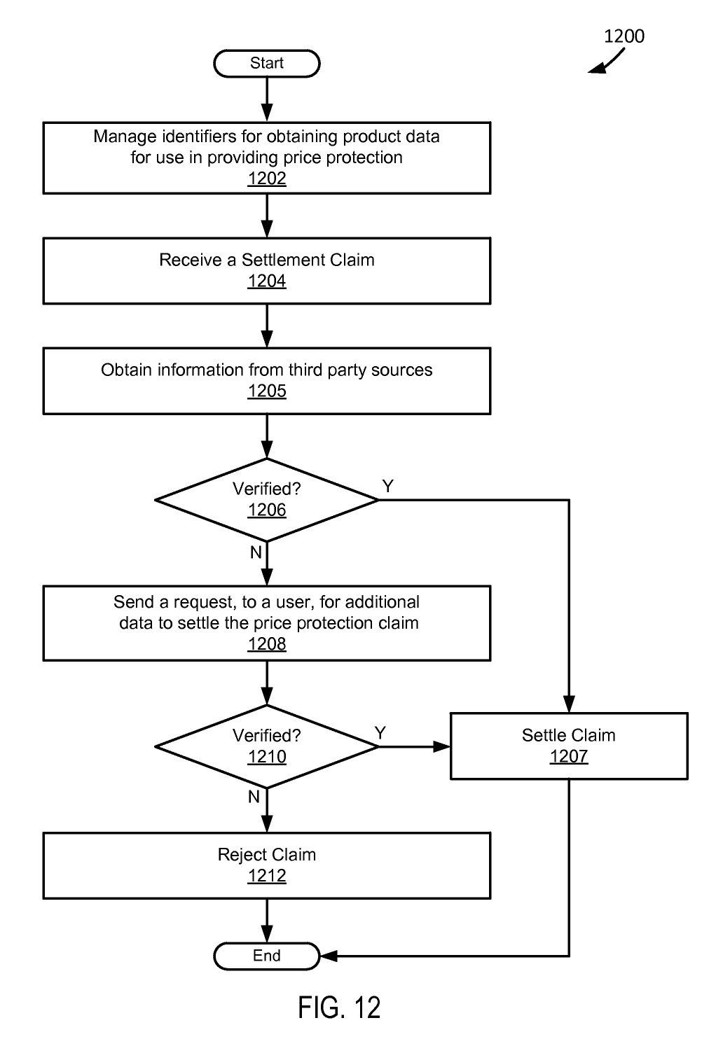

FIG. 12 is a flowchart illustrating a method 1200 for verifying a price protected product conversion. The steps in FIG. 12 are by way of illustration only. The method 1200 may include elements not explicitly depicted, and all elements are not necessary.

At step 1202, identifiers for obtaining product data for use in providing price protection and settling a price protection claim are managed. The identifier management engine 702 can manage the identifiers.

At step 1204, a settlement claim is received. The settlement claim can be received from the user or a component in the system, such as from the third party intermediated marketplace system 108 or the product provider system 106. The verification engine 710 can receive the settlement claim for verification.

At step 1205, product conversion information is obtained, in some embodiments from third party sources, e.g., from the third party intermediated marketplace system 108 or the product provider system 106. The product conversion information may include verification items or identifiers for assisting in obtaining verification items. If the purchase occurred through the third party intermediated marketplace system 108, then the third party intermediated marketplace system 108 may send the product conversion information to the verification engine 710. If the purchase occurred through the product provider system 106, then the product provider system 106 may send the product conversion information to the verification engine 710 automatically.

At step 1206, a determination is made whether the product conversion claim can be verified from the third party sources. In some embodiments, the verification engine 710 may determine whether the product conversion information received from the third party sources satisfies the verification checklist.

If the product conversion claim is verified at step 1206, then at step 1207 the claim is settled. In some embodiments, the product conversion settlement engine settles the claim by providing the appropriate amount to the appropriate entity. The method 1200 then ends.

If the product conversion claim could not be verified at step 1206 (or if no information is received from third party sources), then at step 1208 a request for additional information may be sent to the user. The additional information requested may be for verification items and/or identifiers to assist in obtaining the verification items. In some embodiments, the verification engine 710 may request the information from the user. In other embodiments, the user may provide the information without request, e.g., within the settlement claim.

At step 1210, a determination is made whether the product conversion claim can be verified with the user information. The user information may include verification items or identifiers of verification items. If the user information includes identifiers, the determination may include obtaining the verification items from third party sources, e.g., global distribution system 116, the third party intermediated marketplace system(s) 108 and/or the product provider system(s) 110. In some embodiments, the verification engine 710 may determine whether the information received from the user and/or third party sources satisfies the verification checklist. If the settlement claim is verified, then the method jumps to step 1207 where the claim is settled. The method 1200 then ends.

If the settlement claim is not verified (possibly after additional communications with the user, e.g., information requests), then the settlement claim may be rejected. In some embodiments, the verification engine 710 rejects the settlement claim. The method 1200 then ends.

Those of skill in the art can implement the techniques described herein using a process, an apparatus, a system, a composition of matter, a computer program product embodied on a computer-readable storage medium, and/or a processor, such as a processor configured to execute instructions stored on and/or provided by a memory coupled to the processor. Unless stated otherwise, a component such as a processor or memory described as being configured to perform a task may be implemented as a general component that is configured to perform the task at a given time or a specific component that is manufactured to perform the task. As used herein, the term ‘processor’ refers to one or more devices, circuits, and/or processing cores configured to process data, such as computer program instructions.

Some portions of the detailed description are presented in terms of algorithms and symbolic representations of operations on data bits within a computer memory. These algorithmic descriptions and representations are the means used by those skilled in the data processing arts to most effectively convey the substance to others skilled in the art. An algorithm is here, and generally, conceived to be a sequence of operations leading to a desired result. The operations are those requiring physical manipulations of physical quantities. These quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The apparatus can be specially constructed for the required purposes, or it can comprise a general-purpose computer selectively activated or reconfigured by a computer program stored in the computer. Such a computer program may be stored in a computer-readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus. Alternative ways of controlling the computer can be used, such as ASICs and FPGAs.

For the purpose of clarity, known technical material has not been described in detail to avoid unnecessarily obscuring the invention. The invention is not limited to any implementation described herein. The scope of the invention is limited only by the claims and the invention encompasses numerous alternatives, modifications and equivalents. Numerous specific details are set forth to provide a thorough understanding of the invention. These details are provided as examples and the invention may be practiced according to the claims without some or all these specific details.

We claim:

1. A method comprising:
identifying one or more airline flight specifications of an airline flight ticket offer for an airline flight ticket on a specific flight available at a specific price to a user;
offering price protection at a price protection price for the airline flight ticket with the one or more airline flight specifications on the specific flight, the price protection being a promise that the airline flight ticket with the one or more airline flight specifications on the specific flight can be purchased at or below the specific price during a specified time period, unless no airline flight ticket with the one or more airline flight specifications on the specific flight remains available;
if the user purchases the price protection, then during the specified time period:
if the user has not purchased the airline flight ticket with the one or more airline flight specifications on the specific flight, monitoring alternative airline flight tickets for a different deal to offer to the user, and if the user purchases the different deal, then terminating the price protection;
if the user has not purchased the airline flight ticket with the one or more airline flight specifications on the specific flight or the different deal, and if a current price for the airline flight ticket with the one or more airline flight specifications on the specific flight increases above the specific price, then determining whether to offer the airline flight ticket or an alternative airline flight ticket at a discounted price below its current asking price, and if the user purchases the airline flight ticket or the alternative airline flight ticket at the discounted price, then terminating the price protection; and
if the current price for the airline flight ticket with the one or more airline flight specifications on the specific flight increases above the specific price to a higher price, and if the user purchases the airline flight ticket at the higher price, then paying a difference between the higher price and the specific price and terminating the price protection.

2. The method of claim 1, wherein the one or more airline flight specifications includes dates of travel and seat class.

3. The method of claim 1, wherein the different deal includes a price lower than the specific price.

4. The method of claim 1, wherein the different deal includes a purchase incentive.

5. The method of claim 1, wherein the paying the difference includes paying the difference to the user.

6. The method of claim 1, wherein the paying the difference includes paying the difference to a provider of the airline flight.

7. The method of claim 1, wherein the paying the difference includes paying the difference to a third party marketplace.

8. The method of claim 1, further comprising:
if during the specified time period no airline flight ticket with the one or more airline flight specifications on the specific flight remains available, and if the user has not purchased the airline flight ticket with the one or more airline flight specifications on the specific flight, the different deal or the alternative airline flight ticket at the discounted price, then paying a penalty to the user.

9. The method of claim 1, further comprising sending a product alert to inform the user of the different deal.

10. The method of claim 1, further comprising sending a product alert to inform the user of an availability of airline flight tickets with the one or more airline flight specifications on the specific flight.

11. The method of claim 1, further comprising sending a product alert to inform the user of the airline flight ticket or the alternative airline flight ticket at the discounted price.

12. A system comprising:
a communications engine configured to identify one or more airline flight specifications of an airline flight ticket offer for an airline flight ticket on a specific flight available at a specific price to a user;
a price protection conversion settlement engine configured to offer price protection at a price protection price for the airline flight ticket with the one or more airline flight specifications on the specific flight, the price protection being a promise that the airline flight ticket with the one or more airline flight specifications on the specific flight can be purchased at or below the specific price during a specified time period, unless no airline flight ticket with the one or more airline flight specifications on the specific flight remains available;
a current product alert management engine configured to, if the user has not purchased the airline flight ticket with the one or more airline flight specifications on the specific flight, monitor alternative airline flight tickets for a different deal to offer to the user during the specified time period;
a damage mitigation engine configured to, if the user has not purchased the airline flight ticket with the one or more airline flight specifications on the specific flight or the different deal, and if a current price for the airline flight ticket with the one or more airline flight specifications on the specific flight increases above the specific price, determine whether to offer the airline flight ticket or an alternative airline flight ticket at a discounted price below its current asking price; and
a product conversion settlement engine configured to, if the current price for the airline flight ticket with the one or more airline flight specifications on the specific flight increases above the specific price to a higher price, and if the user purchases the airline flight ticket at the higher price, pay a difference between the higher price and the specific price and terminating the price protection.

13. The system of claim 12, wherein the one or more airline flight specifications includes dates of travel and seat class.

14. The system of claim 12, wherein the different deal includes a price lower than the specific price.

15. The system of claim 12, wherein the different deal includes a purchase incentive.

16. The system of claim 12, wherein the product conversion settlement engine is configured to pay the difference to the user.

17. The system of claim 12, wherein the product conversion settlement engine is configured to pay the difference includes paying the difference to a provider of the airline flight.

18. The system of claim 12, wherein the product conversion settlement engine is configured to pay the difference includes paying the difference to a third party marketplace.

19. The system of claim 12, wherein the damage mitigation engine is further configured to, if during the specified time period no airline flight ticket with the one or more airline flight specifications on the specific flight remains available, and if the user has not purchased the airline flight ticket with the one or more airline flight specifications on the specific flight, the different deal or the alternative airline flight ticket at the discounted price, determine to pay a penalty to the user.

20. The system of claim 12, wherein the current product alert management engine is further configured to send a product alert to inform the user of an availability of airline flight tickets with the one or more airline flight specifications on the specific flight.

21. The system of claim 12, wherein the current product alert management engine is further configured to send a product alert to inform the user of the airline flight ticket or the alternative airline flight ticket at the discounted price.

22. A system comprising:
means for identifying one or more airline flight specifications of an airline flight ticket offer for an airline flight ticket on a specific flight available at a specific price to a user;
means for offering price protection at a price protection price for the airline flight ticket with the one or more airline flight specifications on the specific flight, the price protection being a promise that the airline flight ticket with the one or more airline flight specifications on the specific flight can be purchased at or below the specific price during a specified time period, unless no airline flight ticket with the one or more airline flight specifications on the specific flight remains available;
means for, during the specified time period, if the user has not purchased the airline flight ticket with the one or more airline flight specifications on the specific flight, monitoring alternative airline flight tickets for a different deal to offer to the user, and if the user purchases the different deal, then terminating the price protection;
means for, during the specified time period, if the user has not purchased the airline flight ticket with the one or more airline flight specifications on the specific flight or the different deal, and if a current price for the airline flight ticket with the one or more airline flight specifications on the specific flight increases above the specific price, then determining whether to offer the airline flight ticket or an alternative airline flight ticket at a discounted price below its current asking price, and if the user purchases the airline flight ticket or the alternative airline flight ticket at the discounted price, then terminating the price protection; and
means for, during the specified time period, if the current price for the airline flight ticket with the one or more airline flight specifications on the specific flight increases above the specific price to a higher price, and if the user purchases the airline flight ticket at the higher price, then paying a difference between the higher price and the specific price and terminating the price protection.
